(19) United States
(12) Patent Application Publication
(10) Pub. No.: US 2006/0146183 A1
(43) Pub. Date: Jul. 6, 2006

(54) Image processing apparatus, encoding device, and methods of same

(76) Inventors: Ohji Nakagami, Tokyo (JP); Kazushi Sato, Kanagawa (JP); Yoichi Yagasaki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/300,317

(22) Filed: Dec. 15, 2005

(30) Foreign Application Priority Data
Dec. 17, 2004 (JP) P2004-365616

(51) Int. Cl. H04N 11/02; H04N 11/04; H04N 7/12

(52) U.S. Cl. 348/397.1; 348/402.1

(57) ABSTRACT

An image processing apparatus and an encoding device able to raise an encoding efficiency and a quality of a decoded image in comparison with a conventional apparatus and methods of the same, specifically image processing apparatus for processing a plurality of blocks defined in a two-dimensional image region in units of blocks, comprising a difference detecting unit for detecting the difference between a color difference enhancement block enhancing a color difference component with respect to a luminance component of a block to be processed in a picture to be processed or a block used for processing that block to be processed and the luminance block of the luminance component obtained from that block and a processing unit for performing processing strongly reflecting an influence of the color difference component of the block to be processed or processing not causing loss of information of the color difference component even when the difference detected by the difference detecting unit exceeds a predetermined threshold value compared with a case where the difference does not exceed the predetermined threshold value.

### CROSS REFERENCES TO RELATED APPLICATIONS

The present invention contains subject matter related to Japanese Patent Application No. 2004-365616 filed in the Japan Patent Office on Dec. 17, 2004, the entire contents of which being incorporated herein by reference.

### BACKGROUND OF THE INVENTION

1. Field of Invention

The present invention relates to an image processing apparatus, an encoding device used for encoding image data, and methods of the same.

2. Description of the Related Art

In recent years, apparatuses based on the MPEG (Moving Picture Experts Group) or other system handling image data as digital data and at that time compressing the image data by applying a discrete cosine transform or other orthogonal transform and motion compensation utilizing the redundancy peculiar to image information for the purpose of highly efficient transmission and storage of information have been spreading in both distribution of information by broadcasting stations and reception of information in general homes.

The encoding system called the MPEG4/AVC (Advanced Video Coding) has been proposed as a followup to the MPEG2.4 system. An encoding device of the MPEG4/AVC system individually encodes the luminance component and the color difference component of encoded picture data in macroblock units, but utilizes the fact that the luminance component and the color difference component generally have a high correlation, focuses on the luminance component in various processing such as searching for motion vectors, and uses the results for the encoding of the color difference component.

However, the conventional encoding device explained above utilizes the results of processing of the luminance component for encoding the color difference component as it is even when the difference between the luminance component and the color difference component of each macro block is large, so has the problem that the encoding efficiency of the color difference component and the quality of the image obtained by decoding the color difference component are sometimes lowered

### SUMMARY OF THE INVENTION

It is therefore desirable to provide an image processing apparatus and an encoding device able to improve the encoding efficiency and the quality of the decoded image in comparison with the conventional apparatus and methods of the same.

According to a first aspect of the invention, there is provided an image processing apparatus for processing a plurality of blocks defined in a two-dimensional image region in units of blocks, comprising a difference detecting means for detecting the difference between a color difference enhancement block enhancing a color difference component with respect to a luminance component of a block to be processed in a picture to be processed or a block used for processing that block to be processed and the luminance block of the luminance component obtained from that block and a processing means for performing processing strongly reflecting an influence of the color difference component of the block to be processed or processing not causing loss of information of the color difference component even when the difference detected by the difference detecting means exceeds a predetermined threshold value compared with a case where the difference does not exceed the predetermined threshold value.

According to a second aspect of the invention, there is provided an encoding device encoding a plurality of blocks defined in a two-dimensional image region in units of blocks, comprising a difference detecting means for detecting the difference between a color difference enhancement block enhancing a color difference component with respect to a luminance component of a block to be processed in a picture to be processed or a block used for processing that block to be processed and the luminance block of the luminance component obtained from that block and a processing means for performing processing strongly reflecting an influence of the color difference component of the block to be processed or processing not causing loss of information of the color difference component even when the difference detected by the difference detecting means exceeds a predetermined threshold value compared with a case where the difference does not exceed the predetermined threshold value.

According to a third aspect of the invention, there is provided an image processing method for processing a plurality of blocks defined in a two-dimensional image region in units of blocks comprising a first step of detecting the difference between a color difference enhancement block enhancing a color difference component with respect to a luminance component of a block to be processed in a picture to be processed or a block used for processing that block to be processed and the luminance block of the luminance component obtained from that block and a second step of performing processing strongly reflecting an influence of the color difference component of the block to be processed or processing not causing loss of information of the color difference component even when the difference detected by the difference detecting means exceeds a predetermined threshold value compared with a case where the difference does not exceed the predetermined threshold value.

According to a fourth aspect of the invention, there is provided an encoding method for encoding a plurality of blocks defined in a two-dimensional image region in units of blocks comprising a first step of detecting the difference between a color difference enhancement block enhancing a color difference component with respect to a luminance component of a block to be processed in a picture to be processed or a block used for processing that block to be processed and the luminance block of the luminance component obtained from that block and a second step of performing processing, strongly reflecting an influence of the color difference component of the block to be processed or processing not causing loss of information of the color difference component even when the difference detected by the difference detecting means exceeds a predetermined threshold value compared with a case where the difference does not exceed the predetermined threshold value.

According to a fifth aspect of the invention, there is provided an image processing apparatus for processing a plurality of blocks defined in a two-dimensional image region in units of blocks, comprising: a difference detecting circuit for detecting the difference between a color difference enhancement block enhancing a color difference component with respect to a luminance component of a block to be processed in a picture to be processed or a block used for processing that block to be processed and the luminance block of the luminance component obtained from that block and a processing circuit for performing processing strongly reflecting an influence of the color difference component of the block to be processed or processing not causing loss of information of the color difference component even when the difference detected by the difference detecting circuit exceeds a predetermined threshold value compared with a case where the difference does not exceed the predetermined threshold value.

According to the present invention, an image processing apparatus and an encoding device able to raise the encoding efficiency and the quality of the decoded image in comparison with the conventional apparatuses and methods of the same can be provided.

### BRIEF DESCRIPTION OF THE DRAWINGS

These and other objects and features of the present invention will become clearer from the following description of the preferred embodiments given with reference to the attached drawings, wherein:

FIG. 1 is a view of the configuration of a communication system of a first embodiment of the present invention;

FIG. 2 is a functional block diagram of an encoding device shown in FIG. 1;

FIG. 3 is a view for explaining processing of a thinning circuit shown in FIG. 2;

FIG. 4 is a view for explaining processing of a difference judgment circuit shown in FIG. 2;

FIG. 5 is a view for explaining processing of the difference judgment circuit shown in FIG. 2;

FIG. 6 is a view for explaining judgment table data stored by the difference judgment circuit shown in FIG. 2;

FIG. 7 is a view for explaining the size of block data used in a motion prediction and compensation circuit shown in FIG. 2;

FIG. 8 is a view for explaining search processing of a motion vector in the motion prediction and compensation circuit shown in FIG. 2;

FIG. 9 is a view for explaining a search operation of a motion vector in the encoding device shown in FIG. 2;

FIG. 10 is a view for explaining the processing of a selection circuit of the encoding device of a second embodiment of the present invention;

FIG. 11 is a view for explaining processing for determining the size of the block data of the motion prediction and compensation circuit of the encoding device of a third embodiment of the present invention;

FIG. 12 is a flow chart for explaining processing of a rate control circuit of the encoding device of a fourth embodiment of the present invention; and

FIG. 13 is a flow chart for explaining processing of a rate control circuit of the encoding device of a fifth embodiment of the present invention.

### DESCRIPTION OF THE PREFERRED EMBODIMENTS

Preferred embodiments of the present invention will be described in detail below while referring to the attached figures.

### First Embodiment

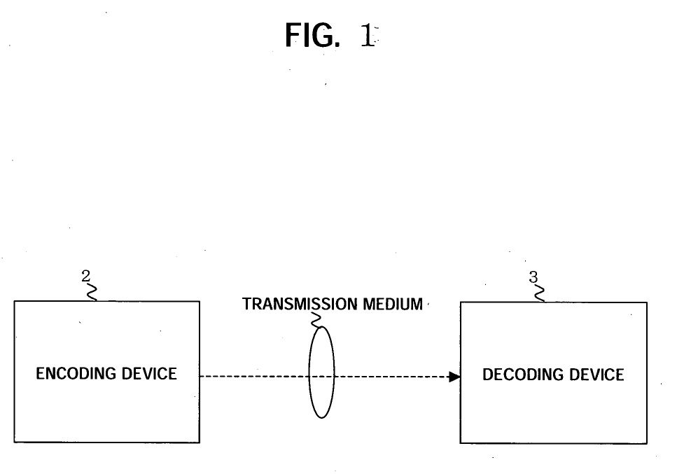

Below, a communication system 1 of the present embodiment will be explained. First, the correspondence between components of the embodiment of the present invention and components of the present invention will be explained. FIG. 1 is a conceptual view of the communication system 1 of the present embodiment. As shown in FIG. 1, the communication system 1 has an encoding device 2 provided on a transmission side and a decoding device 3 provided on a reception side. The encoding device 2 corresponds to the data processing apparatus and the encoding device of the present invention. In the communication system 1, the encoding device 2 on the transmission side generates frame image data (bit stream) compressed by a discrete cosine transform or Karhunen-Loeve transform or other orthogonal transform and motion compensation, modulates the frame image data, then transmits the result via a broadcast satellite, cable TV network, telephone network, mobile phone network, or other transmission medium. On the reception side, after demodulating the image signal received at the decoding device 3, the frame image data expanded by an inverse transform to the orthogonal transform at the time of the modulation and the motion compensation is generated and utilized. Note that the transmission medium may be an optical disk, magnetic disk, semiconductor memory, or other recording medium as well.

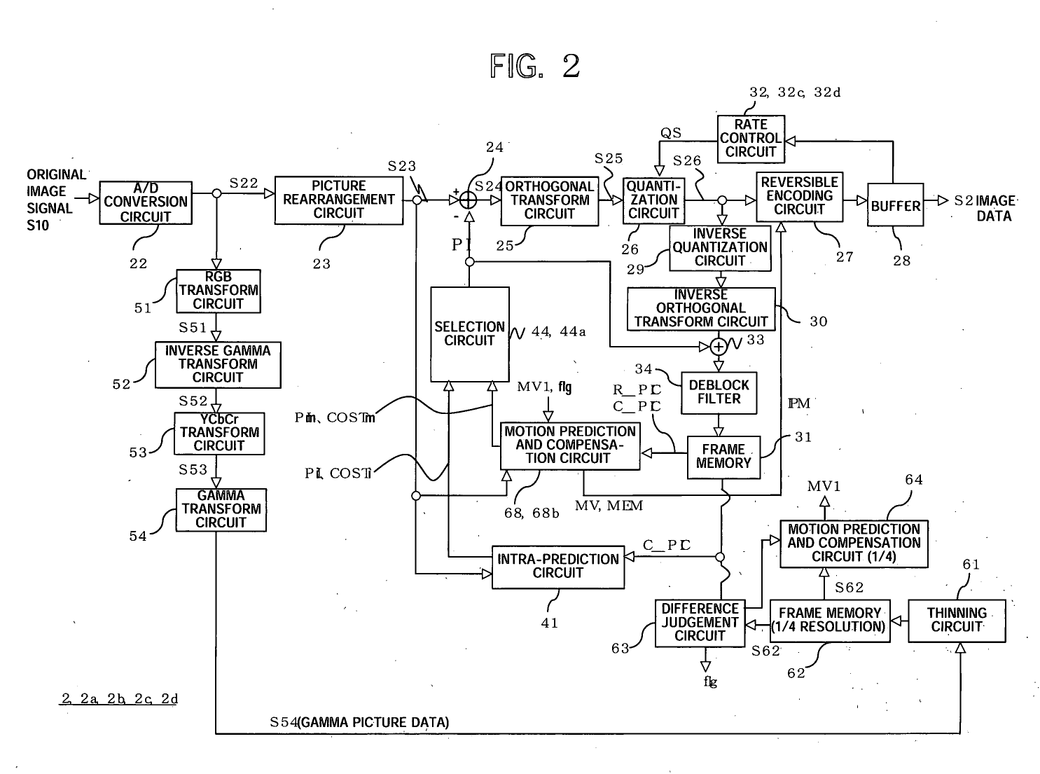

The decoding device 3 shown in FIG. 1 has the same configuration as that of the conventional device and performs decoding corresponding to the encoding of the encoding device 2. Below, the encoding device 2 shown in FIG. 1 will be explained. FIG. 2 is a view of the overall configuration of the encoding device 2 shown in FIG. 1. As shown in FIG. 2, the encoding device 2 has for example an A/D conversion circuit 22, a picture rearrangement circuit 23, a processing circuit 24, an orthogonal transform circuit 25, a quantization circuit 26, a reversible encoding circuit 27, a buffer memory 28, an inverse quantization circuit 29, an inverse orthogonal transform circuit 30, a frame memory 31, a rate control circuit 32, an adder circuit 33, a deblock filter 34, an intra-prediction circuit 41, a selection circuit 44, an RGB transform circuit 51, an inverse gamma transform circuit 52, an YCbCr transform circuit 53, a gamma transform circuit 54, a thinning circuit 61, a frame memory 62, a difference judgment circuit 63, a motion prediction and compensation (¼) circuit 64, and a motion prediction and compensation circuit 68.

The encoding device 2 searches for a motion vector MV1 by a ¼ resolution by using gamma picture data S62 enhanced in the color difference component at the motion prediction and compensation circuit (¼) 64, while searches for the motion vector MV in a search range prescribed based on a motion vector MV1 in reference luminance picture data R_PIC in the motion prediction and compensation circuit 68. In this case, the difference judgment circuit 63 detects the difference between current picture data C_PIC comprised of the luminance component of a recomposed image of picture data S23 to be processed (current) and the gamma picture data S54 (S62) obtained by enhancing the color difference component of the picture data S23. Then, the motion prediction and compensation circuit 68 sets the search range narrower in the case where the detected difference exceeds a predetermined threshold value in comparison with the case where the detected difference does not exceed the predetermined threshold value. Namely, where the difference is large, the influence of the color difference component is strongly reflected in the motion vector search processing in the motion prediction and compensation circuit 68. Due to this, according to the encoding device 2, the reduction of the encoding efficiency of the color difference component and the quality of the image obtained by decoding the color difference component can be avoided.

Below, components of the encoding device 2 will be explained.

[A/D Conversion Circuit 22]

The A/D conversion circuit 22 converts an input analog original image signal S10 comprised of a luminance signal Y, and color difference signals Pb and Pr to digital picture data S22 and outputs this to the picture rearrangement circuit 23 and the RGB transform circuit 51.

[Picture Rearrangement Circuit 23]

The picture rearrangement circuit 23 outputs the original image data S23 obtained by rearranging the frame data in the picture data S22 input from the A/D conversion circuit 22 to the sequence of encoding in accordance with a GOP (Group of Pictures) structure comprised of picture types I, P, and B to the processing circuit 24, the motion prediction and compensation circuit 68, and the intra-prediction circuit 41.

[Processing Circuit 24]

The processing circuit 24 generates image data S24 indicating the difference between the original image data S23 and the prediction image data PI input from the selection circuit 44 and outputs this to the orthogonal transform circuit 25.

[Orthogonal Transform Circuit 25]

The orthogonal transform circuit 25 applies a discrete cosine transform, Karhunen-Loeve transform, or other orthogonal transform to the image data S24 to generate image data (for example DCT coefficient) S25 and outputs this to the quantization circuit 26.

[Quantization Circuit 26]

The quantization circuit 26 quantizes the image data S25 with a quantization scale QS input from the rate control circuit 32 to generate image data S26 (quantized DCT coefficient) and outputs this to the reversible encoding circuit 27 and the inverse quantization circuit 29.

[Reversible Encoding Circuit 27]

The reversible encoding circuit 27 stores the image data obtained by variable length encoding or arithmetic encoding of the image data S26 in the buffer 28. At this time, the reversible encoding circuit 27 stores the motion vector MV input from the motion prediction and compensation circuit 68 or its difference motion vector, identification data of the reference image data, and the intra-prediction mode input from the intra-prediction circuit 41 in header data etc.

[Buffer Memory 28]

The image data stored in the buffer memory 28 is modulated etc. and then transmitted.

[Inverse Quantization Circuit 29]

The inverse quantization circuit 29 generates the data obtained by inverse quantization of the image data S26 and outputs this to the inverse orthogonal transform circuit 30.

[Inverse Orthogonal Transform Circuit 30]

The inverse orthogonal transform circuit 30 outputs the image data generated by applying an inverse transform to the orthogonal-transform in the orthogonal transform circuit 25 to the data input from the inverse quantization circuit 29 to the adder circuit 33.

[Adder Circuit 33]

The adder circuit 33 adds the image data input (decoded) from the inverse orthogonal transform circuit 30 and the prediction image data PI input from the selection circuit 44 to generate the recomposed image data and outputs this to the deblock filter 34.

[Deblock Filter 34]

The deblock filter 34 writes the image data obtained by eliminating only a block distortion of the recomposed image data input from the adder circuit 33 as the reference luminance picture data R_PIC (current luminance picture data C_PIC) with a full resolution into the frame memory 31. Note that, in the frame memory 31, for example the recomposed image data of the picture for the motion prediction and compensation processing by the motion prediction and compensation circuit 68 and the intra-prediction processing in the intra-prediction circuit 41 are sequentially written in units of macro blocks MB finished being processed.

[Rate Control Circuit 32]

The rate control circuit 32 for example generates the quantization scale QS based on the image data read out from the buffer memory 28 and outputs this to the quantization circuit 26.

[Intra-Prediction Circuit 41]

The intra-prediction circuit 41 generates prediction image data PIi of the macro block MB to be processed for each of a plurality of prediction modes such as the intra 4×4 mode and intra 16×16 mode and generates index data COSTi which becomes an index of the code amount of the encoded data based on this and the macro block MB to be processed in the original image data S23. Then, the intra-prediction circuit 41 selects the intra-prediction mode minimizing the index data COSTi. The intra-prediction circuit 41 outputs the prediction image data PIi and the index data COSTi generated corresponding to the finally selected intra-prediction mode to the selection circuit 44. Further, when receiving as input a selection signal S44 indicating that the intra-prediction mode is selected, the intra-prediction circuit 41 outputs a prediction mode IPM indicating the finally selected intra-prediction mode to the reversible encoding circuit 27. Note that, even a macro block MB belonging to a P slice or an S slice is sometimes subjected to intra-prediction encoding by the intra-prediction circuit 41.

The intra-prediction circuit 41 generates for example the index data COSTi based on Equation (1).

$$COSTi = {\sum }_{1 \leq i \leq x} ( SATD + header\_cost ( mode ) ) \qquad ( 1 )$$

Further, in Equation (1), “i” is for example an identification number added to each block data of a size corresponding to the intra-prediction mode composing the macro block MB to be processed. The x in above Equation (1) is “1” in the case of the intra 16×16 mode, and “16” in the case of the intra 4×4 mode. The intra-prediction circuit 41 calculates “SATD+header_cost (mode))” for all block data composing the macro block MB to be processed, adds them, and calculates the index data COSTi. The header_cost (mode) is the index data which becomes the index of the code amount of the header data including the motion vector after the encoding, the identification data of the reference image data, the selected mode, the quantization parameter (quantization scale), etc. The value of the header_cost (mode) differs according to the prediction mode. Further, SATD is index data which becomes the index of the code amount of the difference image data between the block data in the macro block MB to be processed and the previously determined block data (prediction block data) around the block data. In the present embodiment, the prediction image data PIi is defined by one or more prediction block data.

SATD is for example the data after applying a Hadamard transform (Tran) to a sum of the absolute difference between pixel data of a block data Org to be processed and prediction block data Pre as shown in Equation (2). The pixels in the block data are designated by s and t in Equation (2).

$$SATD = {\sum }_{s , t} ( \vert Tran ( Org ( s , t ) - Pre ( s , t ) ) \vert ) \qquad ( 2 )$$

Note that SAD shown in Equation (3) may be used in place of SATD as well. Further, in place of SATD, use may also be made of another index such as SSD prescribed in PMEG4,AVC expressing distortion or residue.

$$SAD = {\sum }_{s , t} ( \vert Org ( s , t ) - Pre ( s , t ) \vert ) \qquad ( 3 )$$

[RGB Transform Circuit 51 to Gamma Transform Circuit 54]

The RGB transform circuit 51, the inverse gamma transform circuit 52, the YCbCr transform circuit 53, and the gamma transform circuit 54 generate gamma picture data S54 as the luminance signal enhancing (strongly reflecting) the color difference component from the digital picture data S22 comprised of the luminance signal Y and the color difference signals Pb and Pr. The gamma picture data S54 enhanced in the color difference component is thinned to the ¼ resolution at the thinning circuit 61, then used for a motion vector search of the ¼ resolution in the motion prediction and compensation circuit (¼) 64.

The RGB transform circuit 51 performs the number summing computation and bit shift with respect to the digital picture data S22 comprised of the luminance signal Y and the color difference signals Pb and Pr based on Equation (4), generates RGB picture data S51, and outputs this to the inverse gamma transform circuit 52.

$$R = Y + ( 403 / 256 ) Cr \\ G = Y - ( 48 / 256 ) Cb - ( 120 / 256 ) Cr \\ B = Y + ( 475 / 256 ) Cr \qquad ( 4 )$$

The inverse gamma transform circuit 52 performs the coefficient operation shown in Equation (5) on the signals of R, G, and B composing the RGB picture data input from the RGB transform circuit 51, generates new RGB picture data S52 after the coefficient transform, and outputs the result to the YCbCr transform circuit 53.
(R,G,B)=(R,G,B)/2((R,G,B)<170
(R,G,B)=2(R,G,B)−256((R,G,B)≧170) (5)

The YCbCr transform circuit 53 applies the processing shown in Equation (6) to the RGB picture data S52 input from the inverse gamma transform circuit 52 to generate picture data S53 of the luminance component and outputs this to the gamma transform circuit 54.
Y=(183/256)G+(19/256)B+(54/256)R (6)

The gamma transform circuit 54 applies the coefficient operation shown in Equation (7) to the picture data S53 of the luminance input from the YCbCr transform circuit 53 to generate the gamma picture data S54 and outputs this to the thinning circuit 61.
Y=2Y(Y<85)
Y=Y/2+128(Y≧85) (7)

[Thinning Circuit 61]

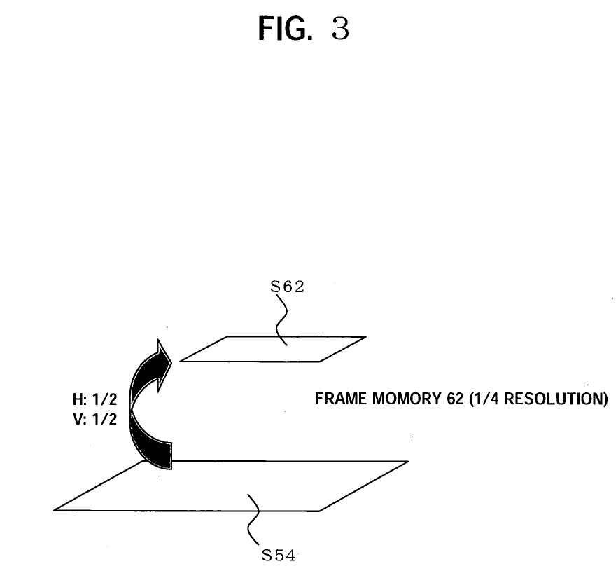

The thinning circuit 61 thins the gamma picture data S54 of the full resolution enhanced in the color difference component input from the gamma transform circuit 54 to the ¼ resolution and writes it into the frame memory 62 as shown in FIG. 3.

[Difference Judgment Circuit 63]

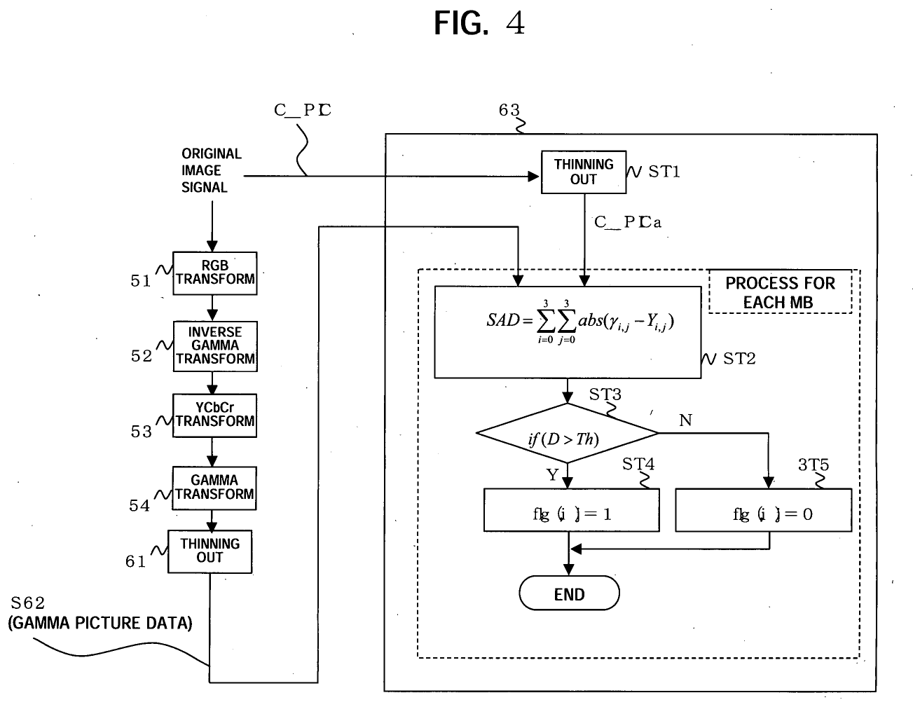

FIG. 4 is a view for explaining the processing of the difference judgment circuit 63.

Step ST1

The difference judgment circuit 63 reads out the current luminance picture data C_PIC of the full resolution from the frame memory 31 and thins this to the ¼ resolution to generate current luminance picture data C_PICa of the ¼ resolution.

Step ST2

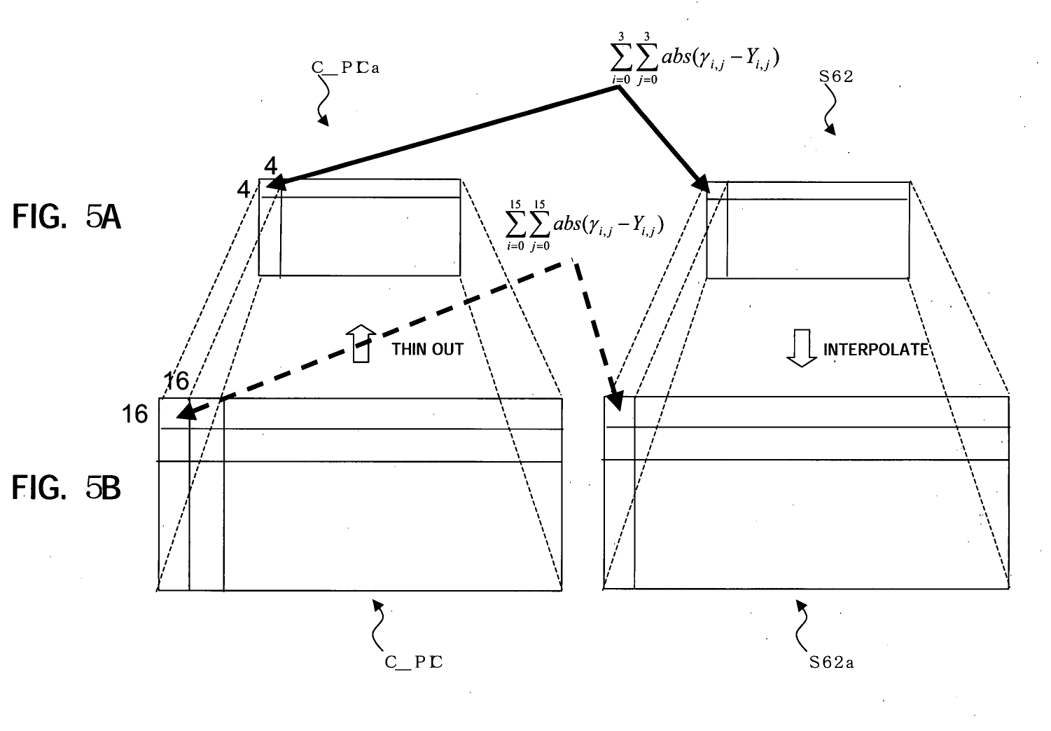

The difference judgment circuit 63, as shown in FIG. 5(A), generates the sum of the absolute difference (index data SAD indicating the difference) of the difference between the current luminance picture data C_PICa of the ¼ resolution input in step ST1 and the gamma picture data S62 of the ¼ resolution read out from the frame memory 62 based on for example the following Equation (8) in units of corresponding macro blocks MB. In Equation (8), γ indicates the luminance value of a macro block MB in the gamma picture data S62, and Y indicates the luminance value of a macro block MB in the current luminance picture data C_PICa. Further, the pixel values in the 4×4 block are designated by (i,j).

$$SAD = {\sum }_{i = 0}^{3} {\sum }_{j = 0}^{3} abs ( {γ}_{i , j} - {Y}_{i , j} ) \qquad ( 8 )$$

Step ST3

The difference judgment circuit 63 judges whether or not the index data exceeds a predetermined threshold value Th.

Step ST4

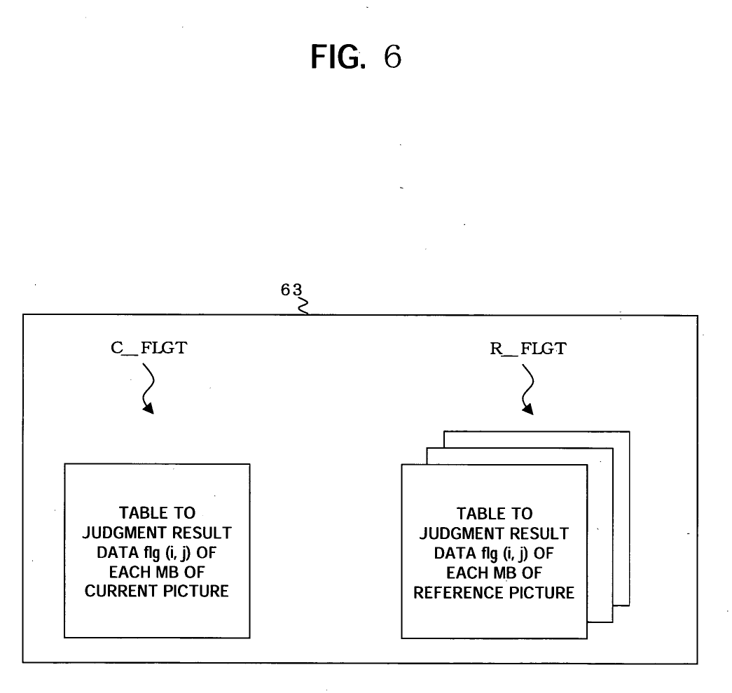

When deciding that the index data exceeds the threshold value Th by the judgment in step ST3, the difference judgment circuit 63 links a judgment result data flg (i,j) indicating a first logic value (for example “1”) with the macro block MB (i,j) to be processed and stores the same as an element of the current judgment table data C_FLGT shown in FIG. 6.

Step ST5

When deciding that the index data does not exceed the threshold value Th by the judgment in step ST3, the difference judgment circuit 63 links the judgment result data flg (i,j) indicating a second logic value (for example “0”) with the macro block MB (i,j) to be processed and stores the same as an element of the current judgment table data C_FLGT shown in FIG. 6.

Note that the difference judgment circuit 63 may generate the index data SAD not by the sum of absolute difference, but by a square sum of the difference. Further, the difference judgment circuit 63, as shown in FIG. 5(B), may interpolate the gamma picture data S62 of the ¼ resolution read out from the frame memory 62 to generate gamma picture data S62a of the full resolution and calculate the index data SAD indicating the sum of absolute difference between this gamma picture data S62a and the current luminance picture data C_PIC of the full resolution read out from the frame memory 31.

The difference judgment circuit 63, as shown in FIG. 6, stores the judgment result data flg (i,j) of all macro blocks MB (i,j) in the current picture data to be processed as the current judgment table data C_FLGT. When the encoding processing for the current picture data ends, as shown in FIG. 6, the difference judgment circuit 63 stores the judgment result data flg (i,j) of the I,P picture data which may be referred to later as the reference judgment table data R_FLGT.

[Motion Prediction and Compensation Circuit (¼) 64]

The motion prediction and compensation circuit (¼) 64 searches for the 8×8 pixel block or 16×16 pixel block minimizing the difference from the 8×8 pixel blocks or 16×16 pixel blocks corresponding to the current macro block MB in the current gamma picture data S62 read out from the frame memory 62 in the reference gamma picture data S62 forming the reference image. Then, the motion prediction and compensation circuit (¼) 64 generates the ¼ resolution motion vector MV1 corresponding to the position of the found pixel block. The motion prediction and compensation circuit (¼) 64 generates the difference based on for example the index data using SATD and SAD explained above. Note that the motion prediction and compensation circuit (¼) 64 will generate one ¼ resolution motion vector MV1 corresponding to one current macro block MB in the case where 8×8 pixel blocks are used as units in the search. On the other hand, the motion prediction and compensation circuit (¼) 64 will generate one ¼ resolution motion vector MV1 corresponding to four adjacent current macro blocks MB in the case where 16×16 pixel blocks are used as units in the search.

[Motion Prediction and Compensation Circuit 68]

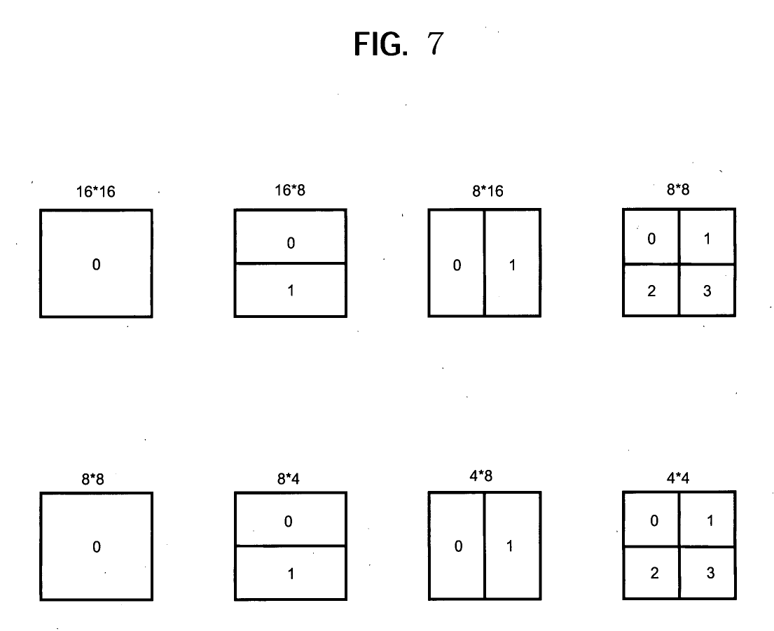

The motion prediction and compensation circuit 68 generates index data COSTm along with the inter-encoding based on the luminance component of the macro block MB to be processed of the original image data S23 input from the picture rearrangement circuit 23. The motion prediction and compensation circuit 68 searches for the motion vector MV of the block data to be processed and generates prediction block data using the block data defined by the motion prediction and compensation mode as units based on the reference luminance picture data R_PIC encoded in the past and stored in the frame memory 31 for each of a previously determined plurality of motion prediction and compensation modes. The size of the block data and the reference luminance picture data R_PIC are defined by for example the motion prediction and compensation mode. The size of the block data is for example 16×16, 16×8, 8×16, and 8×8 pixels as shown in FIG. 7. The motion prediction and compensation circuit 68 determines the motion vector and the reference picture data for each block data. Note that for a block data having the 8×8 size, each partition can be further divided to either of 8×8, 8×4, 4×8, or 4×4.

The motion prediction and compensation circuit 68 uses as the motion prediction and compensation mode, for example, the inter 16×16 mode, inter 8×16 mode, inter 16×8 mode, inter 8×8 mode, inter 4×8 mode, and inter 4×4 mode. The sizes of the block data are 16×16, 8×16, 16×8, 8×8, 4×8, and 4×4. Further, for the sizes of the motion prediction and compensation modes, a forward prediction mode, a backward prediction mode, and a two-way prediction mode can be selected. Here, the forward prediction mode is the mode using image data having a forward display sequence as the reference image data, the backward prediction mode is the mode using image data having a backward display sequence as the reference image data, and the two-way prediction mode is the mode using image data having a forward and backward display sequence as the reference image data. The present embodiment can have a plurality of reference image data in the motion prediction and compensation processing by the motion prediction and compensation circuit 68.

Further, the motion prediction and compensation circuit 68 generates index data COSTm which becomes an index of the sum of the code amount of the block data having a block size corresponding to the motion prediction and compensation mode composing the macro block MB to be processed in the original image data S23 for each of the motion prediction and compensation modes. Then, the motion prediction and compensation circuit 68 selects the motion prediction and compensation mode minimizing the index data COSTm. Further, the motion prediction and compensation circuit 68 generates the prediction image data PIm obtained where the above selected motion prediction and compensation mode is selected. The motion prediction and compensation circuit 68 outputs the prediction image data PIm and the index data COSTm generated corresponding to the finally selected motion prediction and compensation mode to the selection circuit 44. Further, the motion prediction and compensation circuit 68 outputs the motion vector generated corresponding to the above selected motion prediction and compensation mode or the difference motion vector between the motion vector and the predicted motion vector to the reversible encoding circuit 27. Further, the motion prediction and compensation circuit 68 outputs a motion prediction and compensation mode MEM indicating the above selected motion prediction and compensation mode to the reversible encoding circuit 27. Further, the motion prediction and compensation circuit 68 outputs the identification data of the reference image data (reference frame) selected in the motion prediction and compensation to the reversible encoding circuit 27.

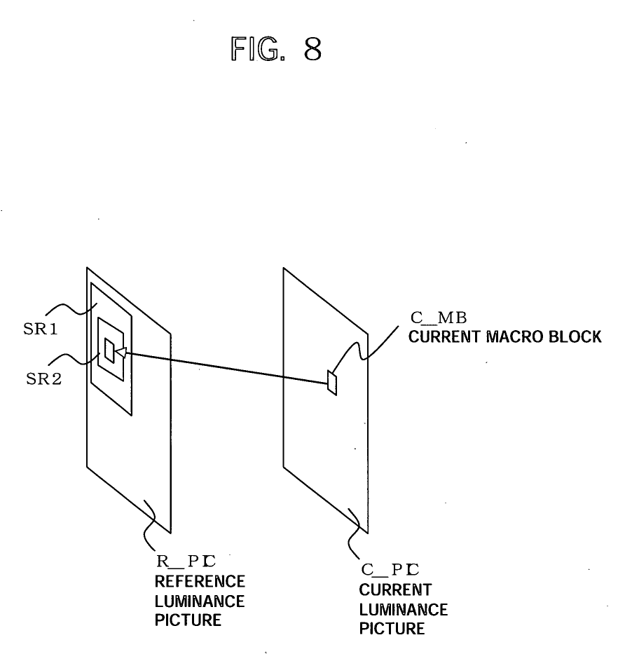

The motion prediction and compensation circuit 68 determines the search range in the reference luminance picture data R_PIC as shown below in the search of the motion vector using the above block data as units. Namely, the motion prediction and compensation circuit 68 acquires the judgment result data flg (i,j) of the macro block MB indicated by the motion vector MV1 input from the motion prediction and compensation circuit (¼) 64 in the reference luminance picture data R_PIC referred to by the above block data to be processed from the judgment table data R_FLGT stored in the difference judgment circuit 63 shown in FIG. 6. Then, when the acquired judgment result data flg (i,j) indicates “1”, the motion prediction and compensation circuit 68 selects the second search range SR2 narrower than the first search range SR1 shown in FIG. 8. On the other hand, when the acquired judgment result data flg (i,j) indicates “0”, the motion prediction and compensation circuit 68 selects the first search range SR1 shown in FIG. 8.

The motion prediction and compensation circuit 68 generates for example the index data COSTm based on Equation (9).

$$COSTm = {\sum }_{1 \leq i \leq x} ( SATD + header\_cost ( mode ) ) \qquad ( 9 )$$

Further, in Equation (9), “i” is for example an identification number added to each block data having a size corresponding to the motion prediction and compensation mode and composing the macro block MB to be processed. Namely, the motion prediction and compensation circuit 68 calculates “SATD+head_cost (mode))” for all block data composing the macro block MB to be processed, adds them, and calculates the index data COSTm. The head_cost (mode) is index data serving as an index of the code amount of the header data including the motion vector after encoding, the identification data of the reference image data, the selected mode, the quantization parameter (quantization scale), etc. The value of the header_cost (mode) differs according to the motion prediction and compensation mode. Further, SATD is index data serving as an index of the code amount of the difference image data between the block data in the macro block MB to be processed and the block data (reference block data) in the reference image data designated by the motion vector MV. In the present embodiment, the prediction image data PIm is defined by one or more reference block data.

SATD is for example the data after applying a Hadamard transform (Tran) to the sum of absolute difference between the pixel data of the block data Org to be processed and the reference block data (prediction image data) Pre as shown in Equation (10).

$$SATD = {\sum }_{s , t} ( \vert Tran ( Org ( s , t ) - Pre ( s , t ) ) \vert ) \qquad ( 10 )$$

Note that SAD shown in Equation (11) may be used in place of the SATD as well. Further, another index expressing the distortion or residue such as the SSD prescribed in MPEG4,AVC may be used in place of SATD.

$$SAD = {\sum }_{s , t} ( \vert Org ( s , t ) - Pre ( s , t ) \vert ) \qquad ( 11 )$$

Below, the motion prediction and compensation operation in the encoding device 2 will be explained.

Step ST11

The motion prediction and compensation circuit (¼) 64 searches for the 8×8 pixel block or the 16×16 pixel block minimizing the difference from the 8×8 pixel blocks or the 16×16 pixel blocks corresponding to the current macro block MB in the current gamma picture data S62 read out from the frame memory 62 in the reference gamma picture data S62 forming the reference image. Then, the motion prediction and compensation circuit (¼) 64 generates a ¼ resolution motion vector MV1 corresponding to the position of the found pixel block.

The motion prediction and compensation circuit 68 performs the processing of steps ST12 to ST15 for all block data in the macro block MB to be processed in the current picture data C_PIC.

Step ST12

The motion prediction and compensation circuit 68 acquires the judgment result data flg (i, j) of the macro block MB indicated by the motion vector MV1 input from the motion prediction and compensation circuit (¼) 64 in the reference luminance picture data R_PIC referred to by the above block data to be processed in the macro block MB to be processed from the judgment table data R_FLGT stored in the difference judgment circuit 63 shown in FIG. 6. Then, the motion prediction and compensation circuit 68 decides whether or not the acquired judgment result data flg (i,j) indicates “1”, proceeds to step ST13 where it indicates “1”, and proceeds to step ST14 where it does not indicate “1”.

Step ST13

The motion prediction and compensation circuit 68 selects a second search range SR2 narrower than the first search range SR1 shown in FIG. 8 in the reference luminance picture data R_PIC.

Step ST14

The motion prediction and compensation circuit 68 selects the first search range SR1 shown in FIG. 8 in the reference luminance picture data R_PIC.

Step ST15

The motion prediction and compensation circuit 68 searches for the reference block data minimizing the difference from the block data of the macro block MB to be processed in the current picture data C_PIC in the search range selected in step ST13 or ST14 in the reference luminance picture data R_PIC and defines the motion vector in accordance with the position of the found reference block data as the motion vector of the block data.

Then, the motion prediction and compensation circuit 68 performs the processing of the above steps ST12 to ST15 for all block data defined in the macro block MB to be processed corresponding to the motion prediction and compensation mode and generates the motion vector. Then, the motion prediction and compensation circuit 68 searches for the motion vector MV of the block data to be processed and generates the prediction block data in units of block data defined by the motion prediction and compensation mode based on the reference luminance picture data R_PIC encoded in the past and stored in the frame memory 31 for each of a previously determined plurality of motion prediction and compensation modes. Then, the motion prediction and compensation circuit 68 generates the index data COSTm serving as the index of the sum of code amount of the block data having a block size corresponding to the motion prediction and compensation mode composing the macro block MB to be processed in the original image data S23 for each of the motion prediction and compensation modes. Then, the motion prediction and compensation circuit 68 selects the motion prediction and compensation mode minimizing the index data COSTm. Further, the motion prediction and compensation circuit 68 generates the prediction image data PIm obtained when the above selected motion prediction and compensation mode is selected.

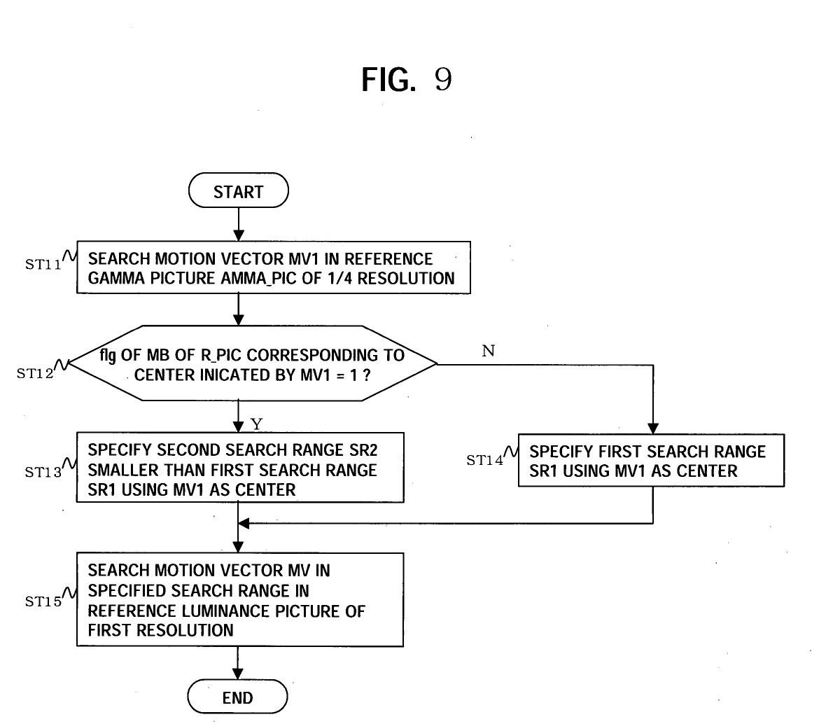

Note that, the motion prediction and compensation circuit 68 performs either of frame encoding or field encoding in a fixed manner or finally selects the one of the frame encoding or field encoding giving the smaller code amount. In this case, the motion prediction and compensation circuit 68 performs the judgment of step ST12 shown in FIG. 9 as shown below in each of the frame encoding and the field encoding.

When the motion prediction and compensation circuit 68 performs the frame encoding and the current picture data C_PIC to be processed is a B or P picture, it selects the second search range SR2 smaller than the first search range SR1 conditional on the motion vector MV1 generated by the motion prediction and compensation circuit (¼) 64 designating the macro block MB whose judgment result data flg (i, j) indicates “1” among macro blocks MB in the reference luminance picture data R_PIC. When the motion prediction and compensation circuit 68 performs the frame encoding and the current picture data C_PIC to be processed is a B or P picture, it selects the second search range SR2 smaller than the first search range SR1 conditional on the motion vector MV1 generated by the motion prediction and compensation circuit (¼) 64 designating the macro block MB whose judgment result data flg (i, j) indicates “1” among macro blocks MB in the current luminance picture data C_PIC.

When the motion prediction and compensation circuit 68 performs the field encoding and the current picture data C_PIC to be processed is a B or P picture, it selects the second search range SR2 smaller than the first search range SR1 conditional on the motion vector MV1 generated by the motion prediction and compensation circuit (¼) 64 designating the macro block MB whose judgment result data fig (i, j) indicates “1” among the macro blocks MB in the top field of the reference luminance picture data R_PIC among the macro blocks MB in the bottom field or among the macro blocks MB in both the top and bottom fields. When the motion prediction and compensation circuit 68 performs the field encoding and the current picture data C_PIC to be processed is a B or P picture, it selects the second search range SR2 smaller than the first search range SR1 conditional on the motion vector MV1 generated by the motion prediction and compensation circuit (¼) 64 designating the macro block MB whose judgment result data flg (i, j) indicates “1” among the macro blocks MB in the top field of the current luminance picture data C_PIC among the macro blocks MB in the bottom field or among the macro blocks MB in both the top and bottom fields.

When the motion prediction and compensation circuit 68 performs the field encoding and the current picture data C_PIC to be processed is a bottom field of the I picture composed by I and P field data, it selects the second search range SR2 smaller than the first search range SR1 conditional on the motion vector MV1 generated by the motion prediction and compensation circuit (¼) 64 designating the macro block MB whose judgment result data flg (i, j) indicates “1” among the macro blocks MB in the top field (field of an inverse parity) of the reference luminance picture data R_PIC. When the motion prediction and compensation circuit 68 performs the field encoding and the current picture data C_PIC to be processed is a bottom field of the I picture composed by I and P field data, it selects the second search range SR2 smaller than the first search range SR1 conditional on the motion vector MV1 generated by the motion prediction and compensation circuit (¼) 64 designating the macro block MB whose judgment result data flg (i, j) indicates “1” among the macro blocks MB in the bottom field (field of the same parity) of the current luminance picture data C_PIC.

When the motion prediction and compensation circuit 68 performs the frame encoding and the current picture data C_PIC to be processed is a B or I picture, it selects the second search range SR2 smaller than the first search range SR1 conditional on the macro block MB whose judgment result data flg (i, j) indicates “1” existing within the predetermined range in the reference luminance picture data R_PIC defined based on the macro block MB indicated by the motion vector MV1 generated by the motion prediction and compensation circuit (¼) 64. When the motion prediction and compensation circuit 68 performs the frame encoding and the current picture data C_PIC to be processed is a B or I picture, it selects the second search range SR2 smaller than the first search range SR1 conditional on the macro block MB whose judgment result data flg (i, j) indicates “1” existing within a predetermined range in the current luminance picture data C_PIC defined based on the macro block MB indicated by the motion vector MV1 generated by the motion prediction and compensation circuit (¼) 64.

When the motion prediction and compensation circuit 68 performs the field encoding and the current picture data C_PIC to be processed is a bottom field of an I picture comprised of I and P field data, it selects a second search range SR2 smaller than the first search range SR1 conditional on the macro block MB whose judgment result data flg (i, j) indicates “1” existing within a predetermined range in the top field (field of inverse parity) of the reference luminance picture data R_PIC defined based on the macro block MB indicated by the motion vector MV1 generated by the motion prediction and compensation circuit (¼) 64. When the motion prediction and compensation circuit 68 performs the field encoding and the current picture data C_PIC to be processed is a bottom field of an I picture comprised of I and P field data, it selects a second search range SR2 smaller than the first search range SR1 conditional on the macro block MB whose judgment result data flg (i, j) indicates “1” existing within a predetermined range in the top field (field of inverse parity) of the current luminance picture data C_PIC defined based on the macro block MB indicated by the motion vector MV1 generated by the motion prediction and compensation circuit (¼) 64.

[Selection Circuit 44]

The selection circuit 44 specifies the smaller data between the index data COSTm input from the motion prediction and compensation circuit 68 and the index data COSTi input from the intra-prediction circuit 41 and outputs the prediction image data PIm or PIi input corresponding to the specified index data to the processing circuit 24 and the adder circuit 33. Further, when the index data COSTm is smaller, the selection circuit 44 outputs a selection signal S44 indicating that inter-encoding (motion prediction and compensation mode) is selected to the motion prediction and compensation circuit 68. On the other hand, when the index data COSTi is smaller, the selection circuit 44 outputs the selection signal S44 indicating that intra-encoding (intra-prediction mode) is selected to the motion prediction and compensation circuit 68. Note that, in the present embodiment, it is also possible if all index data COSTi and COSTm generated by the intra-prediction circuit 41 and the motion prediction and compensation circuit 68 are output to the selection circuit 44 and the minimum index data is specified in the selection circuit 44.

Below, an overall operation of the encoding device 2 shown in FIG. 2 will be explained. The image signal input is first converted to a digital signal at the A/D conversion circuit 22. Next, the frame image data is rearranged in the picture rearrangement circuit 23 in accordance with the GOP structure of the image compression information output. The original image data S23 obtained by that is output to the processing circuit 24, the motion prediction and compensation circuit 68, and the intra-prediction circuit 41.

Next, the processing circuit 24 detects the difference between the original image data S23 from the picture rearrangement circuit 23 and the prediction image data PI from the selection circuit 44 and outputs image data S24 indicating the difference to the orthogonal transform circuit 25. Next, the orthogonal transform circuit 25 applies a discrete cosine transform or Karhunen-Loeve transform or other orthogonal transform to the image data S24 to generate the image data (DCT coefficient) S25 and outputs this to the quantization circuit 26. Next, the quantization circuit 26 quantizes the image data S25 and outputs the image data (quantized DCT coefficient) S26 to the reversible encoding circuit 27 and the inverse quantization circuit 29. Next, the reversible encoding circuit 27 applies reversible encoding such as variable length encoding or arithmetic encoding to the image data S26 to generate the image data S28 and stores this in the buffer 28. Further, the rate control circuit 32 controls the quantization rate in the quantization circuit 26 based on the image data S28 read out from the buffer 28.

Further, the inverse quantization circuit 29 quantizes the image data S26 input from the quantization circuit 26 and outputs the result to the inverse orthogonal transform circuit 30. Then, the inverse orthogonal transform circuit 30 performs the inverse transform processing to that of the orthogonal transform circuit 25 to generate the image data and outputs the image data to the adder circuit 33. The adder circuit 33 adds the image data from the inverse orthogonal transform circuit 30 and the prediction image data PI from the selection circuit 44 to generate the recomposed image data and outputs this to the deblock filter 34. Then, the deblock filter 34 generates the image data obtained by eliminating the block distortion of the recomposed image data and writes this as the reference image data into the frame memory 31.

Then, the intra-prediction circuit 41 performs the intra-prediction processing explained above and outputs the prediction image data PIi and the index data COSTi of the result to the selection circuit 44. Further, the RGB transform circuit 51, the inverse gamma transform circuit 52, the YCbCr transform circuit 53, and the gamma transform circuit 54 generate the gamma picture data S54 as the luminance signal enhancing (strongly reflecting) the color difference component from the picture data S22. Then, the difference judgment circuit 63, the motion prediction and compensation circuit (¼) 64, and the motion prediction and compensation circuit 68 perform the processing explained by using FIG. 3 to FIG. 9 and output the prediction image data PIm and the index data COSTm of the results thereof to the selection circuit 44. Then, the selection circuit 44 specifies the smaller data between the index data COSTm input from the motion prediction and compensation circuit 68 and the index data COSTi input from the intra-prediction circuit 41 and outputs the prediction image data PIm or PIi input corresponding to the specified index data to the processing circuit 24 and the adder circuit 33.

As explained above, the encoding device 2 searches for the motion vector MV1 by ¼ resolution by using the gamma picture data S62 enhanced in the color difference component in the motion prediction and compensation circuit (¼) 64 and searches for the motion vector MV within the search range prescribed based on the motion vector MV1 in the reference luminance picture data R_PIC in the motion prediction and compensation circuit 68. In this case, the difference judgment circuit 63 detects the difference between the current picture data C_PIC comprised of the luminance component of the recomposed image of the picture data S23 to be processed (current) and the gamma picture data S54 (S62) obtained by enhancing the color difference component of the picture data S23. The motion prediction and compensation circuit 68 sets the search range narrower in the case where the detected difference exceeds the predetermined threshold value in comparison with the case where the difference does not exceed the predetermined threshold value. Namely, when the difference is large, the influence of the color difference component is strongly reflected upon the motion vector search processing in the motion prediction and compensation circuit 68. Due to this, according to the encoding device 2, the reduction of the encoding efficiency of the color difference component and the quality of the image obtained by decoding the color difference component can be avoided.

### Second Embodiment

In the above embodiment, the case where the search range used in the motion vector search of the motion prediction and compensation circuit 68 was switched based on the judgment table data C_FLGT and R_FLGT generated by the difference judgment circuit 63 was exemplified, but in the present embodiment, an explanation will be given of a case where a selection circuit 44a shown in FIG. 1 controls the selection of the inter-encoding and the intra-encoding based on the judgment table data C_FLGT and R_FLGT. The configuration of an encoding device 2a of the present embodiment is basically the same as the encoding device 2 of the first embodiment shown in FIG. 1 except for the processing of the selection circuit 44. Further, the motion prediction and compensation circuit 68 may or may not have the function of switching the search range used in the motion vector search based on the judgment table data C_FLGT and R_FLGT as explained in the first embodiment as in the conventional device. Further, the motion prediction and compensation circuit 68 does not have to search for the motion vector hierarchically. In this case, the motion prediction and compensation circuit (¼) 64 is unnecessary.

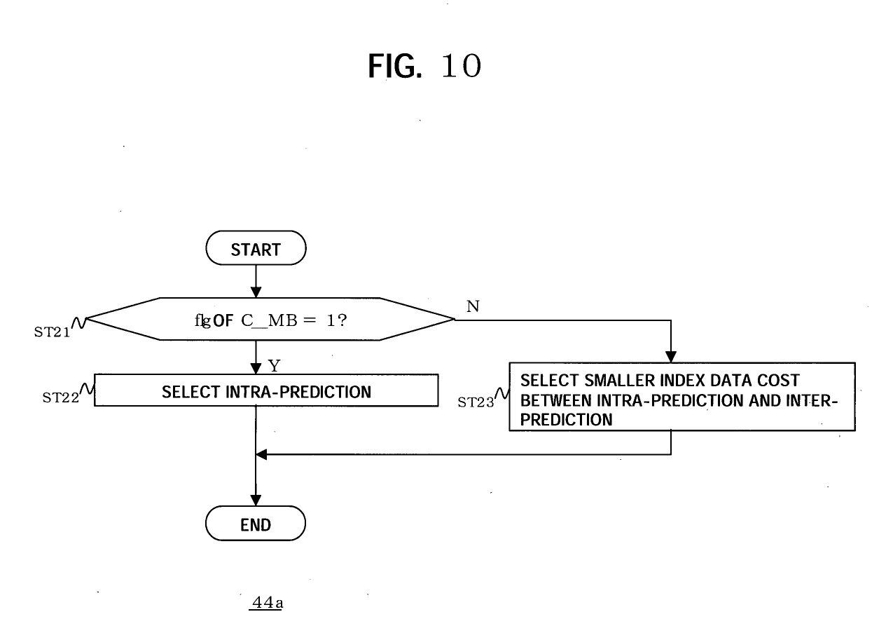

FIG. 10 is a view for explaining the processing of the selection circuit 44a of the encoding device 2a of the present embodiment.

Step ST21

The selection circuit 44a acquires the judgment result data flg (i, j) of the macro block MB to be processed from the difference judgment circuit 63. When deciding that the fig (i, j) indicates “1”, the routine proceeds to step ST22, while when not deciding so, it proceeds to step ST23.

Step ST22

The selection circuit 44a selects the intra-encoding (intra-prediction mode) without comparing the index data COSTm input from the motion prediction and compensation circuit 68 and the index data COSTi input from the intra-prediction circuit 41. Note that the selection circuit 44a may perform processing raising the value of the index data COSTm or lowering the value of the index data COSTi by a predetermined algorithm to facilitate the selection of the intra-prediction mode.

Step ST23

The selection circuit 44a specifies the smaller data between the index data COSTm input from the motion prediction and compensation circuit 68 and the index data COSTi input from the intra-prediction circuit 41 in the same way as the selection circuit 44 of the first embodiment and selects the encoding corresponding to the specified index data between the inter-prediction encoding and the intra-prediction encoding.

In the present embodiment, when the intra-prediction circuit 41 performs the intra-prediction, the prediction block data of both of the luminance component and the color difference component are generated for each macro block MB. On the other hand, in the inter-prediction of the motion prediction and compensation circuit 68, the motion vector MV is finally determined based on the luminance component. In the present embodiment, for each macro block MB, when the difference between the luminance component and the color difference component thereof exceeds the threshold value, by forcibly selecting the intra-prediction, the information loss of the color difference component is lowered, and the encoding error can be suppressed.

### Third Embodiment

In the above embodiments, the case where the search range used in the motion vector search of the motion prediction and compensation circuit 68 was switched based on the judgment table data C_FLGT and R_FLGT generated by the difference judgment circuit 63 was exemplified, but in the present embodiment, an explanation will be given of a case where a motion prediction and compensation circuit 68b shown in FIG. 1 controls the selection method of the block size shown in FIG. 16 based on the judgment table data C_FLGT and R_FLGT. The configuration of an encoding device 2b of the present embodiment is basically the same as the encoding device 2 of the first embodiment shown in FIG. 1 except for the processing of the motion prediction and compensation circuit 68b. Further, the motion prediction and compensation circuit 68b may or may not have the function of switching the search range used in the motion vector search based on the judgment table data C_FLGT and R_FLGT as explained in the first embodiment as in the conventional device. Further, the motion prediction and compensation circuit 68b does not have to search for the motion vector hierarchically. In this case, the motion prediction and compensation circuit (¼) 64 is unnecessary.

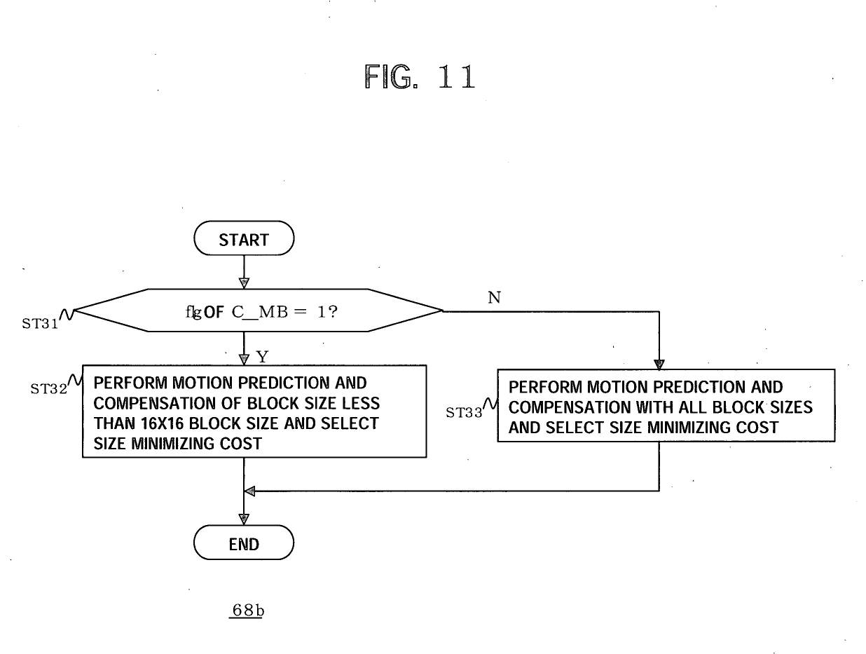

FIG. 11 is a view for explaining the processing for determining the size of the block data of the motion prediction and compensation circuit 68b of the encoding device 2b of the present embodiment.

Step ST31

The motion prediction and compensation circuit 68b acquires the judgment result data flg (i,j) of the macro block MB to be processed from the difference judgment circuit 63, proceeds to step ST32 when deciding that the data flg (i,j) indicates “1”, and proceeds to step ST33 when not deciding so.

Step ST32

The motion prediction and compensation circuit 68b generates the index data COSTm for the motion prediction and compensation mode corresponding to a block size less than the 16×16 block size shown in FIG. 7 and selects the motion prediction and compensation mode minimizing the same. Note that, the motion prediction and compensation circuit 68 may apply processing weighting the index data COSTm so as to make the selection of the motion prediction and compensation mode corresponding to the block size of 16×16 harder.

Step ST33

The motion prediction and compensation circuit 68b performs processing for generation of the motion vector MV1 by using the block data of the sizes shown in FIG. 7 in the same way as the motion prediction and compensation circuit 68 of the first embodiment.

In the present embodiment, for each macro block MB, selection of 16×16 intra-prediction easily causing encoding error of the color difference information can be made harder, and encoding error of the color difference component can be suppressed when the difference between the luminance component and the color difference component thereof exceeds the threshold value.

### Fourth Embodiment

In the above embodiments, the case where the search range used in the motion vector search of the motion prediction and compensation circuit 68 was switched based on the judgment table data C_FLGT and R_FLGT generated by the difference judgment circuit 63 was exemplified, but in the present embodiment, an explanation will be given of a case where a rate control circuit 32c shown in FIG. 1 switches the method of determination of the quantization scale QS based on the judgment table data C_FLGT and R_FLGT. The configuration of an encoding device 2c of the present embodiment is basically the same as the encoding device 2 of the first embodiment shown in FIG. 1 except for the processing of the rate control circuit 32c. Further, the motion prediction and compensation circuit 68 may or may not have the function of switching the search range used in the motion vector search based on the judgment table data C_FLGT and R_FLGT as explained in the first embodiment as in the conventional device. Further, the motion prediction and compensation circuit 68 does not have to search for the motion vector hierarchically. In this case, the motion prediction and compensation circuit (¼) 64 is unnecessary.

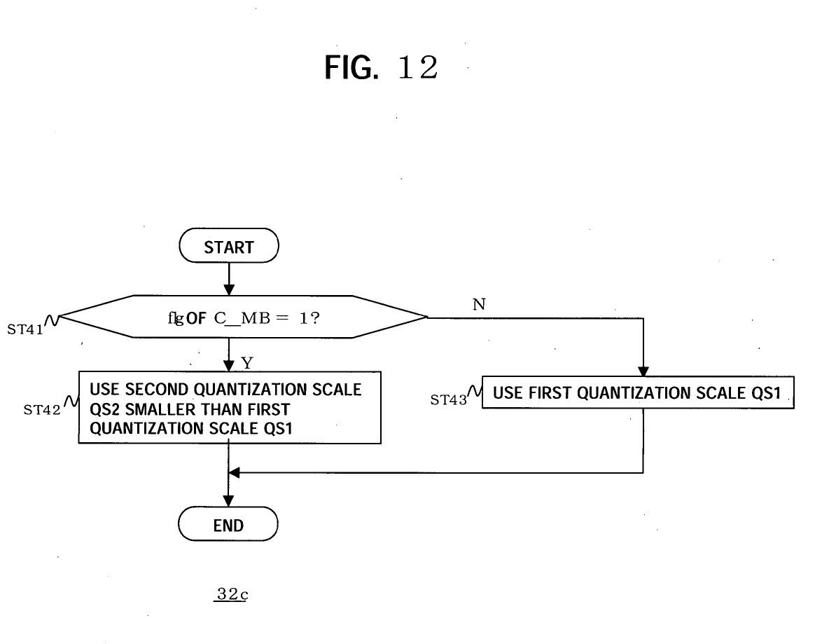

FIG. 12 is a flow chart for explaining the processing of the rate control circuit 32c of the encoding device 2c of the present embodiment.

Step ST41

The rate control circuit 32c acquires the judgment result data flg (i,j) of the macro block MB to be processed from the difference judgment circuit 63, proceeds to step ST42 when deciding that the data flg (i, j) indicates “1”, and proceeds to step ST43 when not deciding so.

Step ST42

The rate control circuit 32c generates the quantization scale QS based on the image data read out from the buffer memory 28, performs processing reducing the value of this quantization scale QS by a predetermined ratio, and outputs the quantization scale QS after the processing to the quantization circuit 26.

Step ST43

The rate control circuit 32c generates the quantization scale QS based on the image data read out from the buffer memory 28 and outputs this quantization scale QS to the quantization circuit 26.

In the present embodiment, for each macro block MB, by reducing the quantization scale QS when the difference between the luminance component and the color difference component thereof exceeds a threshold value, the information loss of the color difference component is lowered, and encoding error can be suppressed.

### Fifth Embodiment

In the above embodiments, the case where the search range used in the motion vector search of the motion prediction and compensation circuit 68 was switched based on the judgment table data C_FLGT and R_FLGT generated by the difference judgment circuit 63 was exemplified, but in the present embodiment, an explanation will be given of a case where a rate control circuit 32c shown in FIG. 1 switches the method of determination of the quantization scale QS based on the judgment table data C_FLGT and R_FLGT. The configuration of an encoding device 2c of the present embodiment is basically the same as the encoding device 2 of the first embodiment shown in FIG. 1 except for the processing of the rate control circuit 32c. Further, the motion prediction and compensation circuit 68 may or may not have the function of switching the search range used in the motion vector search based on the judgment table data C_FLGT and R_FLGT as explained in the first embodiment as in the conventional device. Further, the motion prediction and compensation circuit 68 does not have to search for the motion vector hierarchically. In this case, the motion prediction and compensation circuit (¼) 64 is unnecessary.

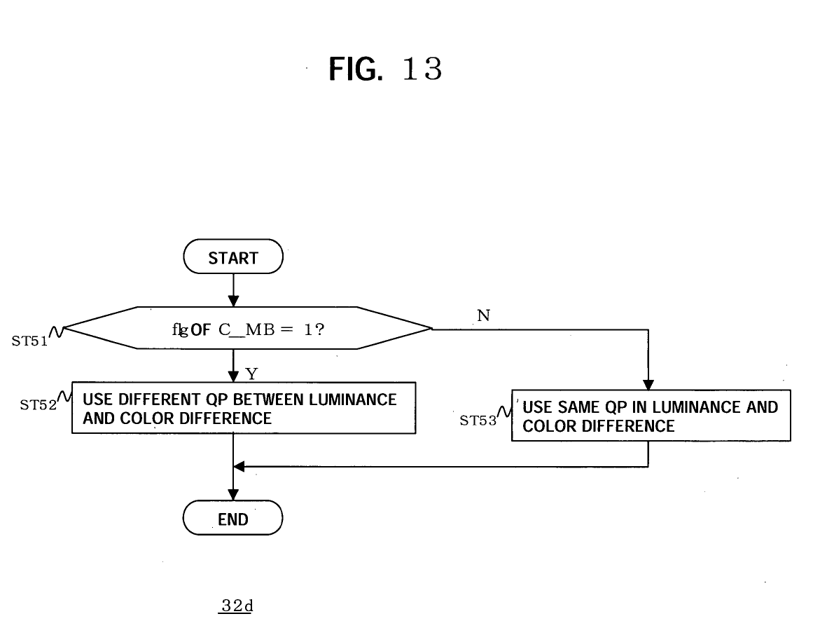

FIG. 13 is a flow chart for explaining the processing of the rate control circuit 32d of the encoding device 2c of the present embodiment.

Step ST51

The rate control circuit 32d acquires the judgment result data flg (i,j) of the macro block MB to be processed from the difference judgment circuit 63, proceeds to step ST52 when deciding that the data flg (i, j) indicates “I”, and proceeds to step ST53 when not deciding so.

Step ST52

The rate control circuit 32c generates the quantization scale QS based on the image data read out from the buffer memory 28 for each of the luminance component and the color difference component and outputs this to the quantization circuit 26. The quantization circuit 26 quantizes the luminance component of the image data S25 by using the quantization scale QS input from the rate control circuit 32c. On the other hand, the quantization circuit 26 quantizes the color difference component of the image data S25 by using the quantization scale QS of the color difference component input from the rate control circuit 32c.

Step ST53

The rate control circuit 32c generates the quantization scale QS based on the image data read out from the buffer memory 28 and outputs this quantization scale QS to the quantization circuit 26. The quantization circuit 26 performs the quantization by using the quantization scale QS of the luminance component input from the rate control circuit 32c without distinguishing between the luminance component and the color difference component.

In the present embodiment, for each macro block MB, by individually setting the quantization scales QS for the luminance component and the color difference component when the difference of the luminance component and the color difference component thereof exceeds a threshold value, the information loss of the color difference component is lowered, and the encoding error can be suppressed.

The present invention is not limited to the above embodiments. For example, the case where the present invention was applied to an encoding device 2 of the MPEG4/AVC method was exemplified in the above embodiments, but the processing concerning the block to be processed can also be applied to the case where the processing performed by using the luminance component and the color difference component is included.

Further, a portion of the processing of the thinning circuit 61, the frame memory 62, the difference judgment circuit 63, the motion prediction and compensation circuit (¼) 64, the motion prediction and compensation circuits 68 and 68a, the rate control circuits 32c and 32d, and the selection circuit 44a may be accomplished by executing a program by a computer, CPU etc.

The present invention can be applied to a system encoding image data.

It should be understood by those skilled in the art that various modifications, combinations, sub-combinations and alterations may occur depending on design requirements and other factors insofar as they are within the scope of the appended claims or the equivalents thereof.

What we claim is:

1. An image processing apparatus for processing a plurality of blocks defined in a two-dimensional image region in units of blocks, comprising:
a difference detecting means for detecting the difference between a color difference enhancement block enhancing a color difference component with respect to a luminance component of a block to be processed in a picture to be processed or a block used for processing that block to be processed and the luminance block of the luminance component obtained from that block and
a processing means for performing processing strongly reflecting an influence of the color difference component of the block to be processed or processing not causing loss of information of the color difference component even when the difference detected by the difference detecting means exceeds a predetermined threshold value compared with a case where the difference does not exceed the predetermined threshold value.

2. An image processing apparatus as set forth in claim 1, wherein
said apparatus further comprises a thinning means for thinning said color difference enhancement block of a first resolution to generate a color difference enhancement block of a second resolution and storing this in a memory;
said processing means comprises:
a first searching means for searching for a color difference enhancement block of a second resolution corresponding to said color difference enhancement block of said second resolution obtained from said block to be processed and read from said memory in a reference color difference enhancement picture and
a second searching means searches for a luminance block corresponding to a luminance block of a first resolution obtained from said block to be processed in a search range which said first searching means in said reference luminance picture defines based on the position of said found color difference enhancement block and generates a motion vector of said block to be processed based on the positional relationship between said found luminance block and said block to be processed; and
said second searching means defines said search range narrower in the case where said difference detected by said difference detecting means exceeds said predetermined threshold value for a block corresponding to said color difference enhancement block in said reference color difference enhancement picture which said first searching means finds or said block in a picture to be processed corresponding to said color difference enhancement block compared with when it does not exceed said predetermined threshold value.

3. An image processing apparatus as set forth in claim 1, wherein
said apparatus further comprises a thinning means for thinning said color difference enhancement block of a first resolution to generate a color difference enhancement block of a second resolution and storing this in a memory;
said processing means comprises:
a first searching means for searching for a color difference enhancement block of a second resolution corresponding to said color difference enhancement block of said second resolution obtained from said block to be processed and read from said memory in a reference color difference enhancement picture and
a second searching means searches for a luminance block corresponding to a luminance block of a first resolution obtained from said block to be processed in a search range which said first searching means in said reference luminance picture defines based on the position of said found color difference enhancement block and generates a motion vector of said block to be processed based on the positional relationship between said found luminance block and said block to be processed; and
said second searching means defines said search range narrower in the case where there is said block corresponding to said color difference enhancement block in said reference color difference enhancement picture which said first searching means finds or a block where said difference which said difference detecting means detects in a predetermined range defined based on said block in a picture to be processed corresponding to said color difference enhancement block exceeds said predetermined threshold value compared with when there isn't one.

4. An image processing apparatus as set forth in claim 2, wherein said difference detecting means detects a difference between said luminance block comprised of said luminance block of said first resolution obtained from said block to be processed thinned to said second resolution and a color difference enhancement block of said second resolution read out from said memory corresponding to said block to be processed.

5. An image processing apparatus as set forth in claim 2, wherein said difference detecting means detects a difference between a color difference enhancement block of said first resolution generated by interpolating a color difference enhancement block of said second resolution read out from said memory corresponding to said block to be processed and said luminance block of said first resolution obtained from said block to be processed.

6. An image processing apparatus as set forth in claim 2, wherein said processing means
performs quantization processing for quantizing the difference between said block to be processed and a predicted block of said block and
quantizes said difference by a fine quantization scale in the case where said difference detected by said difference detecting means exceeds a predetermined threshold value compared with the case where said difference does not exceed said predetermined threshold value.

7. An image processing apparatus as set forth in claim 2, wherein said processing means
performs quantization processing for quantizing the difference between said block to be processed and a predicted block of said block and
quantizes the luminance component and color difference component of said block to be processed by separate quantization scales based on the amount of data after encoding said difference detected by said difference detecting means exceeds a predetermined threshold value and quantizes the luminance component and color difference component of said block to be processed by the same quantization scale based on the amount of data after encoding when said difference does not exceed said predetermined threshold value.

8. An image processing apparatus as set forth in claim 2, wherein said processing means:
compares the encoding cost due to intra-predictive encoding of said block to be processed and the encoding cost due to inter-predictive encoding and selects the smaller of the encoding costs and
lowers said encoding cost due to said intra-predictive encoding relative to said encoding cost due to said inter-predictive encoding in the case where said difference detected by said difference detecting means exceeds a predetermined threshold value compared with the case where said difference does not exceed said predetermined threshold value.

9. An image processing apparatus as set forth in claim 2, wherein said processing means:
compares the encoding cost due to intra-predictive encoding of said block to be processed and the encoding cost due to inter-predictive encoding and selects the smaller of the encoding costs and
forcibly selects said intra-predictive encoding when said difference detected by said difference detecting means exceeds a predetermined threshold value.

10. An image processing apparatus as set forth in claim 2, wherein said processing means:
compares the encoding cost in the case of using said block to be processed of a first size and the encoding cost in the case of using said block to be processed of a second size smaller than said first size and selects the smaller of the encoding costs and
lowers said encoding cost of said second size relative to said encoding cost of said first size in the case where said difference detected by said difference detecting means exceeds a predetermined threshold value compared with the case where said difference does not exceed said predetermined threshold value.

11. An image processing apparatus as set forth in claim 2, further comprising a color difference enhancement block generating means for generating a color difference enhancement block enhancing a color difference component with respect to a luminance component of a block to be processed.

12. An encoding device encoding a plurality of blocks defined in a two-dimensional image region in units of blocks, comprising:
a difference detecting means for detecting the difference between a color difference enhancement block enhancing a color difference component with respect to a luminance component of a block to be processed in a picture to be processed or a block used for processing that block to be processed and the luminance block of the luminance component obtained from that block and
a processing means for performing processing strongly reflecting an influence of the color difference component of the block to be processed or processing not causing loss of information of the color difference component even when the difference detected by the difference detecting means exceeds a predetermined threshold value compared with a case where the difference does not exceed the predetermined threshold value.

13. An image processing method for processing a plurality of blocks defined in a two-dimensional image region in units of blocks comprising:
a first step of detecting the difference between a color difference enhancement block enhancing a color difference component with respect to a luminance component of a block to be processed in a picture to be processed or a block used for processing that block to be processed and the luminance block of the luminance component obtained from that block and
a second step of performing processing strongly reflecting an influence of the color difference component of the block to be processed or processing not causing loss of information of the color difference component even when the difference detected by the difference detecting means exceeds a predetermined threshold value compared with a case where the difference does not exceed the predetermined threshold value.

14. An encoding method for encoding a plurality of blocks defined in a two-dimensional image region in units of blocks comprising:
a first step of detecting the difference between a color difference enhancement block enhancing a color difference component with respect to a luminance component of a block to be processed in a picture to be processed or a block used for processing that block to be processed and the luminance block of the luminance component obtained from that block and
a second step of performing processing strongly reflecting an influence of the color difference component of the block to be processed or processing not causing loss of information of the color difference component even when the difference detected by the difference detecting means exceeds a predetermined threshold value compared with a case where the difference does not exceed the predetermined threshold value.

15. An image processing apparatus for processing a plurality of blocks defined in a two-dimensional image region in units of blocks, comprising:
a difference detecting circuit for detecting the difference between a color difference enhancement block enhancing a color difference component with respect to a luminance component of a block to be processed in a picture to be processed or a block used for processing that block to be processed and the luminance block of the luminance component obtained from that block and
a processing circuit for performing processing strongly reflecting an influence of the color difference component of the block to be processed or processing not causing loss of information of the color difference component even when the difference detected by the difference detecting circuit exceeds a predetermined threshold value compared with a case where the difference does not exceed the predetermined threshold value.
